(19) United States
(12) Patent Application Publication
(10) Pub. No.: US 2010/0112396 A1
(43) Pub. Date: May 6, 2010

(54) FIELD HYDROGEN GENERATION SYSTEM

(76) Inventor: Avery N. Goldstein, Troy, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/594,123

(22) PCT Filed: Mar. 31, 2008
(86) PCT No.: PCT/US08/58892

§ 371 Date: Sep. 30, 2009

Related U.S. Application Data
(60) Provisional application No. 60/909,028, filed on Mar. 30, 2007.

(51) Int. Cl. B01J 19/08; H01M 8/04; F01D 15/00

(52) U.S. Cl. 429/19; 422/186; 416/146 R; 977/773

(57) ABSTRACT

A field hydrogen generation system. Includes a flexible housing transparent to visible light and a photoelectrochemical cell adapted to be received within a volume of the housing. A quantity of feedstock liquid within the housing is in contact with said photoelectrochemical cell. A conduit is in fluid communication between the volume of the housing and a hydrogen collection vessel.

### RELATED APPLICATION

This application claims priority of U.S. Provisional patent application Ser. No. 60/909,028 filed Mar. 30, 2007, which is incorporated herein by reference.

### FIELD OF THE INVENTION

The present invention in general relates to a system and process for hydrogen generation and in particular to a system and process for generation of hydrogen for temporary installations or usage remote from infrastructure.

### BACKGROUND OF THE INVENTION

An impediment to the usage of hydrogen as a chemical fuel is the logistics of delivery to a point of usage. Part of the logistics difficulties associated with the use of hydrogen as a chemical fuel is a low energy density per volume, as well as safety concerns associated with the explosive nature of hydrogen. By way of example, hydrogen gas pressurized to 5000 pounds per square inch still requires more than 10 volume equivalents relative to typical aviation jet fuel. This low energy density per volume is exacerbated by concern about a small leak and a stray spark igniting hydrogen in transit whether in a pipeline or pressurized cylinder.

Efforts to address the logistics problems of hydrogen transport have included on-site reforming of a fuel feedstock such as methane, ammonia, and gasoline. Unfortunately, on-site hydrogen production with reforming increases the logistics burden in requiring not only fuel feedstock but also electricity, other gases, and utilities in general. An alternative to reforming is electrolysis which while able to form hydrogen from water nonetheless requires considerable inputs of electrical energy that are obtained from line power or inside electrical generation which again increases the logistics burden. As a result of logistics problems associated with hydrogen, this otherwise attractive fuel remains an unattractive option for remote usage from transportation and/or utility infrastructure.

Thus, there exists a need for system to generate hydrogen at a site of field usage.

### SUMMARY OF THE INVENTION

A field hydrogen generation system. Includes a flexible housing transparent to visible light and a photoelectrochemical cell adapted to be received within a volume of the housing. A quantity of feedstock liquid within the housing is in contact with said photoelectrochemical cell. A conduit is in fluid communication between the volume of the housing and a hydrogen collection vessel.

### BRIEF DESCRIPTION OF THE DRAWINGS

FIG. 1 is a schematic of an inventive field hydrogen generation system according to the present invention inclusive of several optional components; and

FIG. 2 is a schematic of an alternate flexible housing adapted to receive a photoelectrochemical hydrolysis cell in which hydrogen generation is spatially distant from oxygen generation.

### DETAILED DESCRIPTION OF THE INVENTION

The present invention has utility in generating hydrogen with a compact and highly transportable system that operates independent of transportation and utility infrastructure. A photoelectrochemical cell (PEC) capable of generating hydrogen from a feedstock such as water, ammonia, and organic compounds inclusive of aliphatics is provided with dimensions suitable to insert within the volume of a flexible housing transparent to visible light. Upon enclosing the PEC in the housing with a quantity of feedstock and exposing the PEC to sunlight, hydrogen is generated. The hydrogen is conveyed to a hydrogen storage vessel by way of a conduit in fluid communication between the interior volume of the housing and the vessel. Since the PEC cell is thin and the flexible housing in the form of a plastic bag is also compact and lightweight, the footprint of an inventive hydrogen generation system for transport into the field is quite small. In instances where the PEC feedstock is water, the water can be transported into the field or collected in the field. The inventive system is particularly well suited in instances where a mobile hydrogen generation source is needed remote from logistical support and is particularly well suited for military field operations, camping, power generation for remote villages and communities, disaster relief, and lunar exploration.

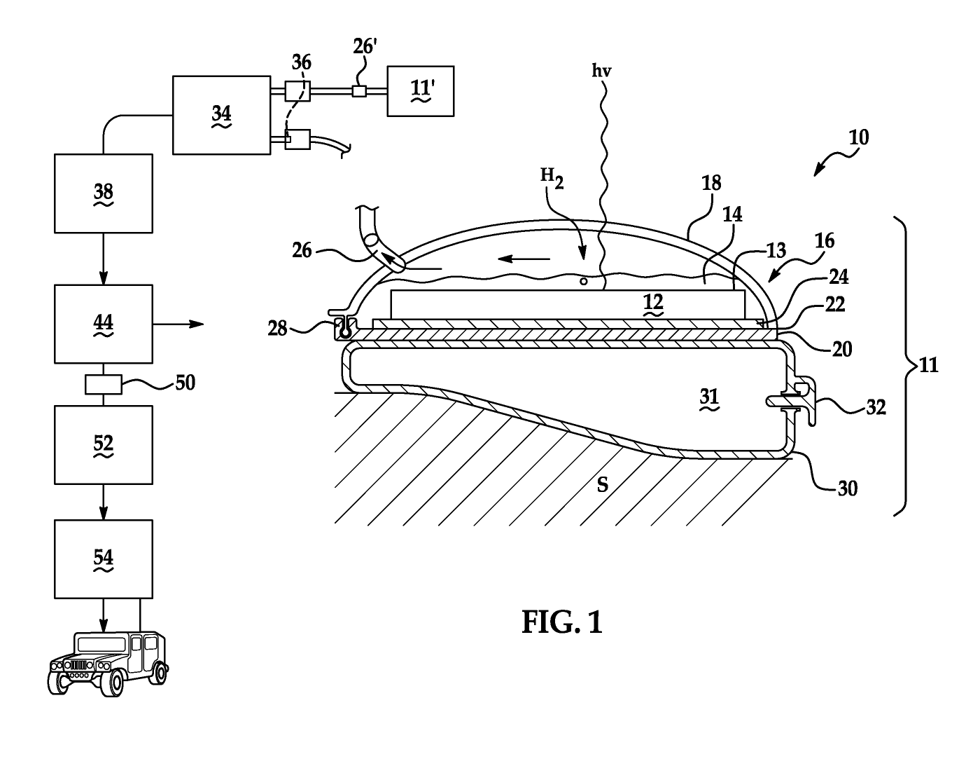

Referring now to FIG. 1, a schematic of an inventive system is depicted generally at 10. The system for field hydrogen generation 10 includes a photoelectrochemical cell (PEC) that when in contact with a feedstock upon exposure to a suitable wavelength of light creates a charge that in turn performs electrochemistry on the feedstock so as to produce hydrogen gas. It is appreciated that while one electrode of the PEC generates hydrogen, the other counter electrode generates an oxidation product in the form of a liquid species or gaseous species. Preferably, the PEC includes a light harvester, a nanocrystalline semiconductor that illustratively includes II-VI semiconductors such as cadmium selenide or cadmium sulfide; III-V semiconductors such as binary, ternary, and quaternary materials of gallium arsenide, gallium aluminum arsenide, gallium aluminum indium arsenide; IV semiconductors such as silicon and doped germanium; transition metal oxides and chalcogenides such as titanium dioxide, tungsten oxide, mixed metal oxides containing two or more metals, mixed metal sulfides, mixed metal selenides, and mixed metal sulfides-selenides. Most preferably, the PEC 12 is of a type disclosed in U.S. Pat. Nos. 6,060,026 and 6,361,660. It is appreciated that bulk thin films of the above-detailed semiconductors are also operative herein to harvest solar photons to generate conductive electrons and holes with sufficient energy to produce hydrogen gas. The PEC 12 in addition to a light harvester also includes a cathode electrode and an anode electrode. The PEC 12 regardless of form or composition is provided with a top surface that upon exposure to sunlight generates conductive electrons and holes which are conveyed effectively to one of the two electrodes in contact with a feedstock 14 so as to induce an electrochemical reaction with the feedstock. The feedstock 14 is preferably water, yet it is appreciated that other conventional feedstocks are readily electrolyzed based on conventional chemistries. In addition to water, a feedstock 14 illustratively includes aqueous ammonia and organic compounds.

The flexible housing 16 has a top layer 18 that is transparent to the visible light portion of the solar spectrum as denoted by h v. The housing 16 includes a backing layer 20 that is sealed along edges 22 to define a volume within V dimensioned to receive the PEC 12. The backing layer 20 is optionally formed of a different material than the upper layer 18 and is illustratively of a greater thickness, opaque, compositionally different, or includes a reflective mirrored coating 24. A conduit 26 is provided in the housing 16 to allow hydrogen gas and counter electrode generated gases to exit the housing 16. Optionally, the housing 16 is provided with a hydrogen-tight and feedstock-tight reclosable seal 28 such as a ribbon fastener. While the housing 16 is detailed as well suited to surround a PEC 12 in contact with feedstock 14 to generate hydrogen while resting on a level planar substrate S, it is appreciated that the placement of a nonlevel substrate will cause a liquid feedstock 14 to flow to the lowest portion of the housing 16 thereby potentially leaving a portion of the PEC 12 out of contact with feedstock 14 and effectively reducing the surface area of top surface 13 of PEC 12 generating hydrogen. Optionally, to account for a nonlevel surface S, a leveling chamber 30 is provided. While the leveling chamber 30 is depicted as being affixed to backing layer 20, it is appreciated that a leveling chamber 30 is also provided as an article separate from housing 16. The leveling chamber 30 is filled with a material capable of flowing to level feedstock 14 so as to preferably completely cover PEC 12. A fill for leveling chamber 30 illustratively includes air, sand, polymeric beads such as expanded polystyrene, and flowable gels. Optionally, leveling chamber 30 includes a sealable port 32 so as to allow for adjustment of the quantity of fill 31 within the leveling chamber 30.

The conduit 26 extends to a hydrogen collection vessel 34. Preferably, a one-way check valve 36 is provided intermediate between the collection vessel 34 and the conduit 26 to prevent backflow of hydrogen into the volume V. Typically, duplicate PECs contained within housings are provided to simultaneously feed the collection vessel 34 with a duplicate unit 11 denoted with primed reference numerals relative to unit 11. The hydrogen collection vessel 34 can be rigid or flexible and is contemplated to be maintained at a low pressure of from 1 to 10 atmospheres. A conduit 40 interconnects the vessel 34 a compressor 38 that functions to increase the pressure of the hydrogen and a possible counter electrode gas, if present in vessel 34. Optionally, a separator 42 is provided in line with the compressor 38 that is selectively permeable to either the counter electrode gas or hydrogen to create a counter electrode waste gas stream and a hydrogen enriched gas stream 46 with the hydrogen enriched gas stream 46 optionally being passed through a second compressor 50 before entering hydrogen storage 52. It is appreciated that the hydrogen storage 52 can be in the form of a low pressure tank of less than 200 psi, a high pressure tank of above 200 psi, or a solid hydrogen storage substance. Optionally, a portion of the hydrogen produced is used to generate electricity with a generator 54, the generator being a fuel cell, turbine, or piston-driven device. The electricity produced by the generator 54 is used to power the compressors 38 and 50, if present, as well as the separator 42, if present. Hydrogen from within the hydrogen storage 52 and/or electricity produced by the generator 54, or a combination thereof, are provided to a consumptive device such as portable electronics or a vehicle. An electrical plug complementary to the electricity consumptive device is preferably provided to facilitate charge transfer. In a simplified embodiment where the hydrogen collection vessel 34 contains hydrogen and oxygen in a stoichiometric ratio of 2:1, this highly explosive mixture is drawn by a compressor on board the end use consumer vehicle or turbine directly into consumer storage or usage.

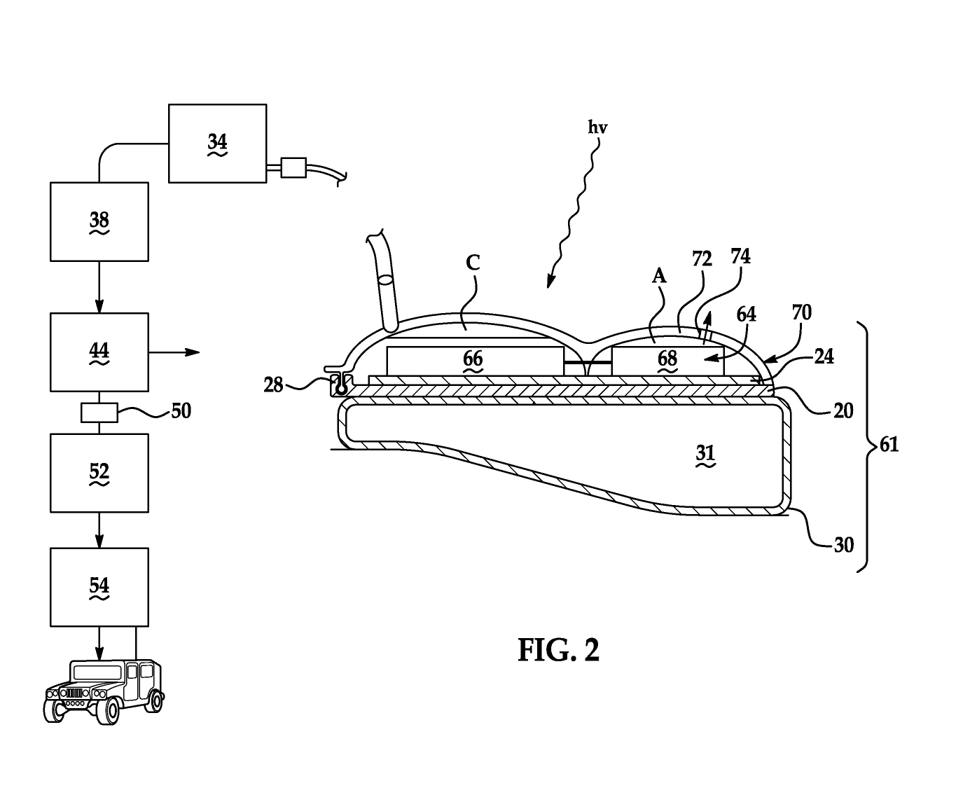

Referring now to FIG. 2 where like numerals correspond to those detailed with respect to FIG. 1, a unit 61 is provided that includes a PEC 64 having spatially separated cathode and anode sections 66 and 68, respectively. The cathode and anode sections 66 and 68 are electrically coupled together. The housing 70 has a backing layer 20 and an upper layer 72. The upper layer 72 creates a cathode volume C with the backing layer 20 in fluid communication with conduit 26 for the passage of hydrogen to a hydrogen collection vessel 34 and an anodic volume A from which the counter ion evolved gas is vented to the atmosphere through valve 74. As a result, hydrogen collection vessel 36 only contains hydrogen thereby simplifying subsequent handling and obviating the need for a separator 42 although one is still optionally used in instances where a higher degree of hydrogen purity is desired.

A process for generating hydrogen in the field includes unpacking a unit 11 and filling the housing 16 with feedstock so as to contact the top surface of the PEC 13 or otherwise contact the PEC electrodes. It is appreciated that filling a bladder with feedstock and coupling that bladder to conduits 26 and 26′ provides an efficient process for filling multiple housings 16 and 16′ simultaneously. The conduits 26 and 26′ are then connected to hydrogen collection vessel 34 and upon photons passing through the upper layer 18 and striking the top surface 13 hydrogen is generated that passes into the collection vessel 34. In instances where the surface on which housing 16 is laid is not level, the leveling chamber 30 is partially filled to self-level the feedstock 14. Closure 28 is alternately used to charge the volume V with feedstock 14. Closure 28 is also used to insert PEC 12 that has not been transported within the housing 16. With exposure to sunlight hydrogen is collected, optionally separated from counter electrode gases and stored for later use or used directly to produce electricity or service a consumer.

The present invention allows for a palletized or otherwise small weight and volume hydrogen generation system to be airlifted or carried to a remote location and set up with minimal effort to provide a continual source of hydrogen so long as sunlight and feedstock are available. In instances where the feedstock is water, beyond an initial charge of water delivered with the system, subsequent water requirements can be provided through using the hydrogen so generated to operate a condenser which while lowering the overall energy output of the system renders it independent of a logistics drain and requires only replacement parts and sunlight to operate indefinitely. As a result, a unit in the field is able to establish a forward fueling station in advance of a party advancing to join them and in need of hydrogen or electricity produced therefrom.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A field hydrogen generation system comprising:
a flexible housing transparent to visible light;
a photoelectrochemical cell adapted to be received within a volume of said housing;
a quantity of feedstock liquid within said housing in contact with said photoelectrochemical cell;
a hydrogen collection vessel; and
a conduit in fluid communication between the volume of said housing and said vessel.

2. The system of claim 1 wherein said feedstock is water.

3. The system of claims 1 wherein said flexible housing is a polymeric bag.

4. The system of claim 3 wherein said bag has a resealable closure.

5. The system of claim 1 further comprising a plurality of flexible housings transparent to visible light, each of said plurality of flexible housings containing a photoelectrochemical cell and feedstock and in fluid communication with said hydrogen collection vessel.

6. The system of claim 1 further comprising a leveling chamber intermediate between a bottom surface of said housing and a surface on which said housing rests.

7. The system of claim 1 further comprising a check valve intermediate between said conduit and said hydrogen collection vessel.

8. The system of claim 1 wherein said photoelectrochemical cell is semiconductor nanoparticulate.

9. The system of claim 8 wherein said semiconductor nanoparticulate is silicon or titanate.

10. The system of claim 1 further comprising a compressor that functions to increase the pressure of the hydrogen entering a hydrogen storage.

11. The system of claim 10 further comprising an electric generator of a fuel cell, turbine, or piston-driven device powered by hydrogen from said collection vessel or said hydrogen storage.

12. The system of claim 11 wherein said generator is coupled to portable electronics or a vehicle.

13. The system of claim 12 further comprising a plug to selectively transfer electricity to the portable electronics or the vehicle.
